(19) United States
(12) Patent Application Publication
(10) Pub. No.: US 2012/0284277 A1
(43) Pub. Date: Nov. 8, 2012

(54) EVENT INFORMATION MANAGEMENT SYSTEM, EVENT MANAGEMENT METHOD AND PROGRAM

(75) Inventor: Satoshi Kinoshita, Tokyo (JP)

(73) Assignee: NEC CORPORATION, Tokyo (JP)

(21) Appl. No.: 13/521,119

(22) PCT Filed: Jan. 12, 2011
(86) PCT No.: PCT/JP2011/050336

§ 371 Date: Jul. 9, 2012

(30) Foreign Application Priority Data
Feb. 19, 2010 (JP) 2010-035314

(51) Int. Cl. G06F 17/30

(52) U.S. Cl. 707/741; 707/E17.002

(57) ABSTRACT

When multiple types of monitored objects are sorted into main monitored objects and smaller objects accommodated therein, the states of the smaller objects can be made searchable by only monitoring information about said main monitored objects. The event information management system is provided with: an association information storage unit which stores association information in which association lists comprising main monitored object IDs and subordinate monitored object IDs associated therewith are marked with specific list identifiers; an event management module which, if the attribute information of an input event shows a physical quantity, selects the list identifiers of the association lists containing main monitored object IDs matching the entity ID of said input event, and creates index information in which the list identifiers and the input event attribute information are associated; and an index storage unit which stores the index information for purposes of searching for events.

### TECHNICAL FIELD

The present invention relates to an event information management system which saves and manages the history of events that show the state of a monitored object, and to an event management method as well as a program thereof.

### BACKGROUND ART

As a business work system, known is an event database which makes it possible to search a progress state of work processing by saving the history of occurred events. An event is data showing a change in context information that shows the state of an entity, and the entity is a subject of the information shown by the event occurred in the work processing, e.g., a person, an article, or a place. Normally, the event contains the event occurrence time, context information, and ID (Identification) of the entry that is the subject of the context.

The event database will be described in more details by referring to a case of a business work system for monitoring logistics as a way of example.

The business work system for monitoring logistics may simply need to be in a structure in which a GPS terminal or a temperature sensor is attached to individual items to be delivered and positional information or temperature information of each item as a unit is regularly detected and stored. However, the items are “integrated” step by step in a typical logistics work, e.g., items are loaded on a pallet, the pallet is housed in a container, and the container is loaded on a cargo ship. Thus, in order to reduce the cost as well as the time and effort, it is common to employ a structure in which the position or the temperature is measured by a unit of container or a unit of cargo ship, the positional information or the temperature information of the container or the cargo ship is reflected upon the positional information or the temperature information of the items housed in the container or the cargo ship by various methods to make it possible to track the position or the temperature of each item without providing the GPS or the temperature sensor by a unit of item. Thereby, it becomes possible to search an item exceeding a specific temperature during delivery or to search an item that is left unshipped in a warehouse without measuring the position or the temperature of the item as a unit.

In such business work system, an event containing the positional information or the temperature information as a context occurs, and the entity of the event changes from “item” to “pallet”, to “container”, and to “cargo ship”. It is so structured that an event occurs by a unit of second. However, the item search is not done so frequently in many cases. Further, the items are integrated many times in logistics, so that the number of items to be integrated becomes extremely large. Furthermore, there are many events generated for giving commands to integrate or to release the items in scenes of loading and unloading operations in a process of logistics.

As a related technique thereof, Patent Document 1 discloses a technique which reflects actually measured data regarding the state of a specific object to state information of another object that is related to the specific object. Patent Document 1 discloses that a context providing device upon receiving a request for positional information of a designated object from a terminal traces context information of another related object based on the context information of the designated object, and returns the positional information contained in the traced context information of the related another object based on the context information of the designated object to the terminal as the positional information of the designated object.
Patent Document 1: Japanese Unexamined Patent Publication 2005-293012

However, in a case where the related technique depicted in patent Document 1 is employed for searching an object under a condition that matches the search condition, it is necessary to check the condition information of all the objects. Further, for the object whose condition information is not measured, it is necessary to check the condition information of all the objects. For the object whose condition information is not measured, it is necessary to trace context information of another object based on link information contained in context information regarding that object and to check the condition information contained in the traced context information regarding the traced another object. Thus, with the related technique of Patent Document 1, there is such an issue that the load for executing the search processing is increased as the number of the objects whose condition information is not measured becomes greater and the time required for completing the search becomes longer.

The issue of the technique depicted in Patent Document 1 will be described by referring to a case of the business work system for monitoring logistics as a way of example. With the business work system for monitoring logistics, it is necessary to perform a setting for associating each item to a pallet while a plurality of items are loaded on the pallet and to trace the context information of the associated pallet from the context information of each item when searching the item that exceeds a specific temperature during delivery. When the temperature recorded in the context information of the traced pallet matches the search condition, that item is the search result. Thus, the greater the number of the items loaded on the pallet is, the more the load for executing the search processing is increased.

An object of the present invention is to overcome the issue of the related technique and, when monitored objects are classified into an monitored object and the other monitored object housed therein, to make it possible to search the state of the other monitored object and to effectively suppress the load for executing the search processing even when the number of the monitored objects is increased.

### DISCLOSURE OF THE INVENTION

In order to achieve the foregoing object, the event information management system according to the present invention is characterized to include: an event input module which sequentially inputs events containing attribute information that is information showing state of a monitored object and an entity ID as an individual identifier of the monitored object that is a subject of the attribute information; an association setting module which operates when the attribute information of the inputted event shows an individual identifier that is different from the entity ID of the event, sets the entity ID of the event to a main monitored object ID, sets the individual identifier shown by the attribute information of the event to a subordinate monitored object ID, and creates association information by applying a specific list identifier to an association list in which the main monitored object ID is associated with the subordinate monitored object ID; an association information storage unit which stores the created association information; an index information creation module which operates when the attribute information of the inputted event shows a physical quantity value regarding the monitored object, searches whether or not the entity ID of the event is registered as the main monitored object ID in the association information storage unit and, when judged as being registered, creates index information in which the list identifier corresponding to the main monitored object ID is associated with the physical quantity value shown by the attribute information of the event; and an index storage unit which stores the created index information for searching the event.

Further, the event management method according to the present invention is so characterized that: an event input module sequentially inputs events containing attribute information that is information showing state of a monitored object and an entity ID as an individual identifier of the monitored object that is a subject of the attribute information; when the attribute information of the inputted event shows an individual identifier that is different from the entity ID of the event, an association setting module sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to an association information storage unit; when the attribute information of the inputted event shows a physical quantity value regarding the monitored object, an index information creation module searches the main monitored object ID that matches the entity ID of the event from the association information storage unit, creates index information in which the list identifier corresponding to the main monitored object ID is associated with the physical quantity value shown by the attribute information of the event, and stores it to an index storage unit for searching the event.

Furthermore, the event information management program according to the present invention is characterized as a program for causing a computer to execute: an event input function which sequentially inputs events containing attribute information that is information showing state of a monitored object and an entity ID as an individual identifier of the monitored object that is a subject of the attribute information; an association information creating function which operates when the attribute information of the inputted event shows an individual identifier that is different from the entity ID of the event, sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to a storage unit; and an index information creating function which operates when the attribute information of the inputted event shows a physical quantity value regarding the monitored object, searches whether or not the entity ID of the event is registered as the main monitored object ID in the association information and, when judged as being registered, creates index information in which the list identifier corresponding to the main monitored object ID is associated with the physical quantity value shown by the attribute information of the event, and stores it to the storage unit for searching the event.

The invention stores the association information in which the list identifier is applied to a combination of the main monitored object and the subordinate monitored object, and creates and stores the index information in which the list identifier of the association list containing the main monitored object ID that matches the entity ID of an event is associated with the attribute value of the event every time an event is inputted. Thus, for a search request, it is possible to search the list identifier that corresponds to the attribute value that matches the search condition from the index information and to output the monitored object ID in the association list associated with the list identifier as the search result. Therefore, the subordinate monitored object can be treated as a search target without acquiring and saving the event associated with the subordinate monitored object. Further, even when the number of subordinate monitored objects associated with the main monitored object is increased, it only needs to add the subordinate monitored object ID to the association list. Therefore, it is possible to suppress the memory use amount and to effectively suppress the time required for the search processing.

### BRIEF DESCRIPTION OF THE DRAWINGS

FIG. 1 is a functional block diagram showing the structure of an event information management system of a first exemplary embodiment according to the present invention;

FIG. 2 is a flowchart showing an example of operations of the event information management system of the exemplary embodiment disclosed in FIG. 1;

FIG. 3 is a flowchart showing an example of operations of the event information management system of the exemplary embodiment disclosed in FIG. 1;

FIG. 4 is a table showing an example of an event history stored in an event storage unit according to the exemplary embodiment disclosed in FIG. 1;

FIG. 5 is a table showing an example of index information stored in an index storage unit according to the exemplary embodiment disclosed in FIG. 1;

FIG. 6 is a table showing an example of association information stored in an association information storage unit according to the exemplary embodiment disclosed in FIG. 1;

FIG. 7 is a functional block diagram showing the structure of an event information management system of a second exemplary embodiment according to the present invention;

FIG. 8 is a flowchart showing an example of operations of the event information management system of the exemplary embodiment disclosed in FIG. 7; and

FIG. 9 is a flowchart showing an example of operations of the event information management system of the exemplary embodiment disclosed in FIG. 8.

### BEST MODES FOR CARRYING OUT THE INVENTION

Hereinafter, exemplary embodiments according to the present invention will be described by referring to the drawings.

### First Exemplary Embodiment

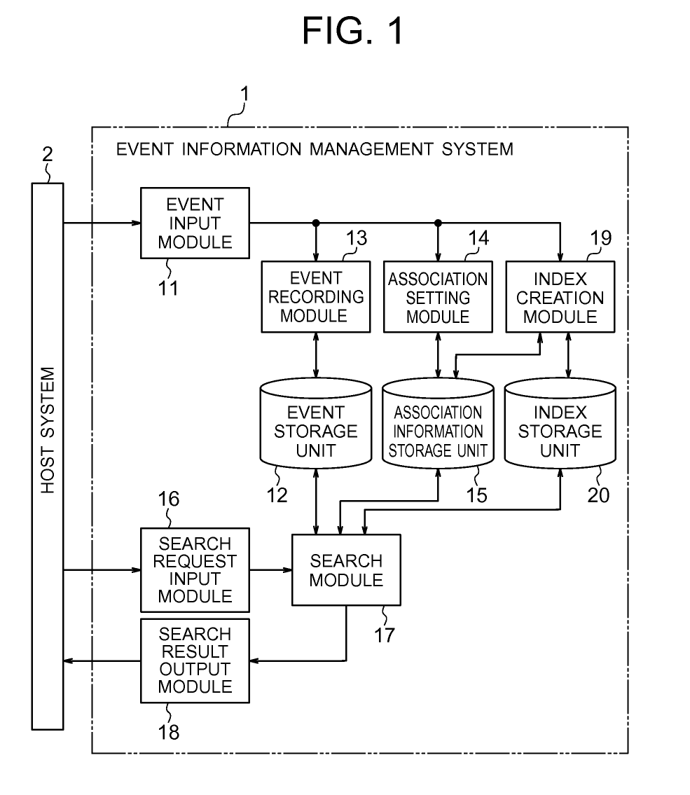

FIG. 1 is a functional block diagram showing the structure of an event information management system 1 of a first exemplary embodiment according to the present invention. The basic structure of the event information management system 1 of the first exemplary embodiment includes: an event input module 11 which sequentially inputs events containing attribute information as information showing the state of a monitored object and an entity ID as an individual identifier of the monitored object that is the subject of the attribute information; an association setting module 14 which operates when the attribute information of the inputted event shows an individual identifier that is different from the entity ID of the event to set the entity ID of the event to a main monitored object ID, to set the individual identifier shown by the attribute information of the event to a subordinate monitored object ID, and to create association information by applying a specific list identifier to an association list in which the main monitored object ID and the subordinate monitored object ID are associated; an association information storage unit 15 which stores the created association information; an index information creation module 19 which operates when the attribute information of the inputted event shows a value of a physical quantity regarding the monitored object to search whether or not the entity ID of the event is registered to the association information storage unit 15 as the main monitored object ID and, when judged as being registered, creates index information in which the list identifier corresponding to the main monitored objet ID and the value of the physical quantity shown by the attribute information of the event are associated; and an index storage unit 20 which stores the created index information for searching the event.

The event input module 11 inputs events generated in a host system 2. The host system 2 is a business work system for executing specific business works, and the monitored objects are objects that can be the subjects of the information shown by the event generated in the host system 2, such as a person, an article, and a place. An example of the host system 2 may be a business work system used for monitoring logistics.

The event is data inputted from outside when executing a business work in the host system 2. The individual identifier of the monitored object as the subject of the information shown by the event is the entity ID, and the attribute information contained in the event is information that shows the state of the entity. Further, examples of the attribute information contained in the event may be data inputted by an operation of an administrator, actually measured data of the physical quantity regarding the entity, and the like.

The event information management system 1 of the first exemplary embodiment makes it possible to search the list ID that corresponds to the attribute information that matches the search condition from the index information in response to a search request and to output the monitored object ID contained in the association list of the list ID as the search result. Thus, it is possible to search a subordinate monitored object that matches the search condition without acquiring and saving the event regarding the subordinate monitored object. Therefore, it simply needs to add the subordinate monitored object ID to the association list even when the number of the subordinate monitored objects for the main monitored object is increased. As a result, it becomes possible to suppress the memory use amount and to suppress the load for executing the search processing.

Next, the event information management system 1 of the first exemplary embodiment will be described in details.

As shown in FIG. 1, the event information management system 1 of the first exemplary embodiment includes: the event input module 11 which sequentially inputs events containing attribute information as information showing the state of a monitored object and an entity ID as an individual identifier of the monitored object that is the subject of the attribute information from the host system 2; an event storage unit 12 which accumulates the inputted events and stores those as an event history; an event recording module 13 which applies specific event IDs to the inputted events and stores those to the event storage unit 12; the association setting module 14 which, when the attribute information of the inputted event shows an individual identifier that is different from the entity ID of the event, sets the entity ID of the event to a main monitored object ID, sets the individual identifier shown by the attribute information to a subordinate monitored object ID, and creates association information by applying a specific list identifier to an association list in which the main monitored object ID and the subordinate monitored object ID are associated; the association information storage unit 15 which stores the created association information; the index information creation module 19 which, when the attribute information of the inputted event shows a value of a physical quantity regarding the monitored object, searches whether or not the entity ID of the event is registered to the association information storage unit 15 as the main monitored object ID and, when judged as being registered, creates index information in which the list identifier corresponding to the main monitored objet ID and the value of the physical quantity shown by the attribute information contained in the event are associated; and the index storage unit 20 which stores the created index information for searching the event.

Further, the event information management system 1 of the exemplary embodiment includes: a search request input module 16 which inputs a search request containing the value of a physical quantity designated by the administrator as a search condition; a search module 17 which searches the list identifier that is associated with the value that matches the search condition from the index storage unit in response to the search request, and reads out the main and subordinate monitored objects of the association list related to the searched list identifier from the association information storage unit; and a search result output module 18 which outputs the read out main and subordinate monitored object IDs as the search result.

The event input module 11 includes a function which inputs events generated in the host system 2. The event contains the event generation time, the entity ID and the attribute information that shows the state of the entity. The entity ID is inherent information for identifying the individual of the entity. Further, the entity ID is a structure which contains information showing the type of the entity.

Further, the events inputted to the event input module 11 can be classified into a regular event, an association event, and an association release event depending on the content of the attribute information. The regular event contains the actually measured value of the physical quantity regarding the entity, the association event contains another object ID associated to the entity as the attribute information, and the association release event contains, as the attribute information, a setting release command of the association list that takes the entity as the main monitored object.

For example, in case of events generated in the business work system for monitoring logistics, items, pallets, containers, and cargo ships can be the entities. Thus, the event having the positional information or the temperature information of the item, the pallet, the container, or the cargo ship as the attribute information is the regular event. The event whose entity is the pallet, which contains the ID of the item housed in the pallet as the attribute information and the event whose entity is the container, which contains the ID of the pallet housed in the container as the attribute information is the association event. Further, the event containing an association release command as the attribute information is the association release event.

The event recording module 13 includes a function which applies a unique event ID to an inputted event and sends it out to the event recording unit 12. The event recording unit 12 includes a function which accumulates the event to which the event ID is added and saves it as an event history.

The association setting module 14 includes: a function which, when the inputted event is “association event”, creates a new association list based on the attribute information thereof, and registers it to the association information storage unit 15; and a function which, when the inputted event is “association release event”, registers the event generation time as the end time of the effective time range of the association list that contains the entity ID thereof as the main monitored object ID.

Specifically, when the association event is inputted, the association setting module 14 searches the association list containing the object ID written in the attribute information of the association event as the main monitored object ID from the association information storage unit 15, acquires all the subordinate monitored object IDs in the searched association list, takes the object ID written in the attribute information of the event and the acquired object ID as new subordinate monitored object IDs, creates a new association list in which the entity ID of the event is associated therewith as a new main monitored object ID, and registers new association information in which a new list ID is applied to the association list to the association information storage unit 15. The association information registered at this time contains only the start time of the effective time range recorded therein. The end time is recorded only when the association release event for the association information is inputted.

The association information storage unit 15 includes a function which stores association information in which a specific list identifier and an effective time range of the association list are added to the association list showing a monitored object group treated as one out of the plurality of monitored objects. The association list is a list in which the monitored object group handled as one is classified into the main monitored object and the subordinate monitored objects associated therewith, which contains the main monitored object ID and the subordinate monitored object IDs associated with the main monitored object. The list identifier is expressed as a list ID hereinafter.

In the association list, one, two or more subordinate monitored object ID is associated with a single main monitored object ID. The effective time range includes a start time and an end time, which is the information showing the effective time range of the corresponding association list. This is equivalent to the time range from generation of the relation between the main monitored object and the subordinate monitored object to its release, and the end time is empty at the point where the relation is not released. Further, the association information storage unit 15 holds the whole history of the association information.

In the relation between the monitored objects, the main monitored object is the side to which the objects are integrated and the subordinate monitored objects are the side to be integrated thereto. For example, when items are housed in a container in a case of a business work system for monitoring logistics, the container is the main monitored object and the items are the subordinate monitored objects.

Further, the subordinate monitored objects are not only those directly housed in the corresponding main monitored object but also those housed in the objects that are directly housed, i.e., those housed indirectly in the main monitored object. For example, provided that a container is the main monitored object when a pallet on which items are loaded is housed in the container in the case of the business work system for monitoring logistics, the pallet is the direct subordinate monitored object and the items are the indirect subordinate monitored objects.

The index creation module 19 includes a function which creates the above-described index information when the inputted event is a “regular event”. The index information is information which associates and shows the event ID in common to the one registered in the event storage unit 12, the value of the physical quantity written in the attribute information of that event, and the list ID of the association list that contains the entity ID of that event as the main monitored object ID. In a case where the entity ID of the event is not recorded in the association information storage unit 15 as the main monitored object ID when creating the index information, the index information is created by setting the list ID as “null”.

The index storage unit 20 includes a function which stores the index information created by the index creation module 19 every time a regular event is inputted. When the association list corresponding to the entity of the event is not set in the association information storage unit 15, “null (association information unreferenced value)” is registered as the list ID.

The search request input module 16 includes a function which inputs a search request that contains the physical quantity value designated by the administrator from the host system 2 as the search condition. In addition to the physical quantity designated by the administrator, the type, the time, and the like of the entity designated by the administrator are also contained as the search condition contained in the search request.

The search module 17 includes: a function which searches the index storage unit 20 in response to a search request, and selects the list ID of the physical quantity that matches the search condition; and a function which selects the type of the monitored object ID that matches the entity type of the search condition from all the monitored object IDs contained in the association list of the selected list ID, and sends it to the search result output module 18. Further, the search module 17 may be structured to include a function which, when a plurality of list IDs matching the search condition are selected, selects the ID that matches the entity type of the search condition from a set of all the monitored object IDs contained in the association list of each list ID, and sends it to the search result output module 18.

The search result output module 18 includes a function which outputs the monitored object ID from the search module 17 to the host system 2 as the search result.

In a case where there are a plurality of types of physical quantities that can be the search condition, e.g., positional information and temperature information, the event information management system 1 of the first exemplary embodiment is provided with the index storage unit 20 and the association information storage unit 15 for each type of the attribute information. This makes it possible to set different association information for each type of the physical quantity shown by the attribute information. Further, in the first exemplary embodiment, the association information stored in the association information storage unit 15 contains the effective time range. Thus, it is possible to correspond to chronological changes in the relation between the main monitored object and the subordinate monitored object.

As described, the event management system 1 according to the first exemplary embodiment includes: the association information storage unit 15 which stores the association information in which the list ID is applied to the association list that associates and shows the main monitored object ID and the subordinate monitored object ID associated directly or indirectly with the main monitored object; the index creation module 19 which creates index information in which the list ID of the association list containing the main monitored object ID that matches the entity ID of the inputted event is associated with the attribute value of the event; and the index storage unit 20 which stores the created index information. The search module 17 searches the list ID that matches the search condition from the index information and reads out the monitored object ID contained in the association list of the list ID, and the search result output module 18 outputs the monitored object ID read out by the search module 17 as the search result.

Thereby, the event information management system 1 of the first exemplary embodiment can search the subordinate monitored object without acquiring/saving the event regarding the subordinate monitored object by simply acquiring/saving the event regarding the main monitored object thereof. Further, even when the number of the subordinate monitored objects for the main monitored object is increased, the subordinate monitored object ID is simply added to the association list. Thus, it is possible to suppress the time for updating and searching the event and the memory use amount.

Next, operations of the event information management system 1 of the first exemplary embodiment will be described. Note here that the explanation of the operations provided hereinafter is an exemplary embodiment of an event management method according to the present invention.

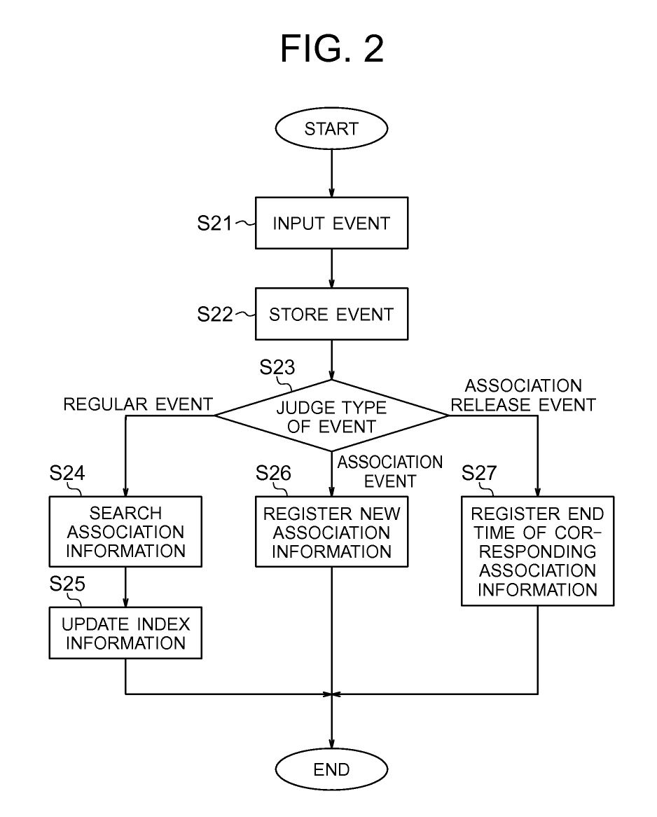

FIG. 2 is a flowchart showing an event recording operation done by the event information management system 1 of the exemplary embodiment. As shown in FIG. 2, in the event information management system 1 of the exemplary embodiment, first, the event input module 11 inputs an event from the host system 2 (step S21 of FIG. 2). The event management module 14 applies an ID to the inputted event and registers it to the event storage unit 12 (step S22 of FIG. 2), and the association setting module 14 and the event creation module 19 judge the type of the event as a “regular event”, an “association event”, or an “association release event”, respectively (step S23 of FIG. 2).

When the inputted event is a regular event, the index creation module 19 refers to the association information storage unit 15, judges whether or not there is an association list that contains the main monitored object ID that matches the entity ID of the event and, when judged that there is, checks whether or not the event generation time is within the effective time range of the association list (step S24 of FIG. 2). When the event generation time is within the effective time range of the association list, the list ID of the association list is extracted.

Subsequently, index information is created by combining the extracted list ID, the event ID of the inputted event, and the attribute information, and registered to the index storage unit 20. In the meantime, when the association list containing the main monitored object ID that matches the entity ID of the inputted event is not stored in the association information storage unit 15 or the event generation time is not within the effective time range thereof, index information is created by setting the list ID to “null (association information unreferenced value)” and registered to the index storage unit 20 (step S25 of FIG. 2).

When the inputted event is an association event, the association setting module 14 searches all the association lists containing the object ID written in the attribute information of the inputted event as the main monitored object ID from the association information storage unit 15, creates a new association list by taking all the monitored object IDs contained in all the searched association lists as the new subordinate monitored object IDs and associating the entity ID of the inputted event therewith as the new main monitored object ID, and adds the new association information in which a list ID is applied to the new association list to the association information storage unit 15. In the effective time range in the new association information of this case, the start time is the generation time of the event, and the end time is empty (step S26 of FIG. 2).

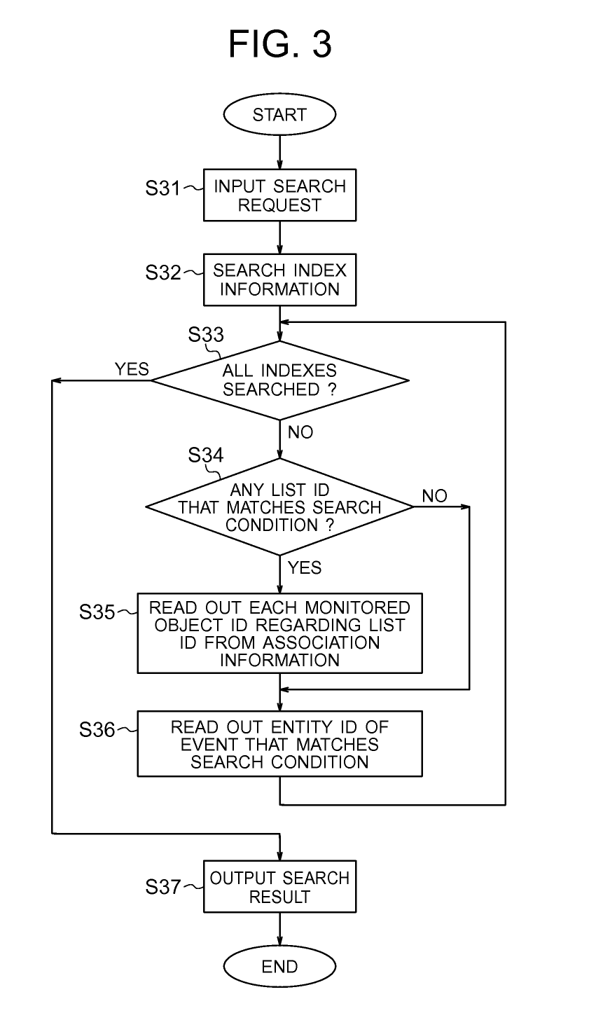

Further, when the inputted event is an association release event, the association setting module 14 searches the association information storage unit 15 based on the entity ID of the inputted event, and registers the generation time of the event as the end time of the effective time range of the matched association information (step S27 of FIG. 2). Next, among the operations of the event information management system 1 according to the first exemplary embodiment, an operation of searching the monitored object that satisfies the search condition will be described by referring to FIG. 3.

First, the search request input module 16 inputs a search request from the host system 2 (step S31 of FIG. 3). In the search request, the search condition is shown. The search condition designates the type and value of the physical quantity, the time, and the entity type. For example, it is designated as “an item whose temperature is 20° C. or higher at time t” as the search condition.

Subsequently, the search module 17 searches inside the index storage unit 20 in response to the search request (step S32 of FIG. 3). When there is index information of the attribute information that matches the search condition and the list ID thereof is other than “null” (Yes in step S34 of FIG. 3), inside the association information storage unit 15 is searched based on the list ID to read out the monitored object ID contained in the association list of the list ID (step S35 of FIG. 3). Subsequently, the event storage unit 12 is searched based on the event ID written in the index information, and the entity ID regarding the event ID is read out (step S36 of FIG. 3). In the meantime, when the list ID of the index information that matches the search condition is “null” (No in step S34 of FIG. 3), the event storage unit 12 is searched based on the event ID contained in the index information, and the entity ID regarding the event ID is read out (step S36 of FIG. 3).

The search module 17 repeats the above-described operation until completing the processing of all the index information that matches the search condition, determines the ID that matches the entity type of the search condition among all the read out IDs as the search result, and the search result output module 18 outputs the search result to the host system 2 (step S37 of FIG. 3).

As described above, the event information management system 1 according to the first exemplary embodiment searches the list ID that matches the search condition from the index storage unit 20 at the time of searching, and reads out and outputs the monitored object ID contained in the association list of the list ID from the association information storage unit 15 as the search result. Thus, it is possible to search the subordinate monitored object under the state that matches the search condition without storing the information regarding the state of the subordinate monitored object. Moreover, it is possible to suppress the memory use amount and the search cost, even when a great number of subordinate monitored objects are associated with the main monitored object.

Next, a specific example of the event information management system 1 according to the first exemplary embodiment will be described. As a specific example, it is assumed that the host system 2 is the business work system which monitors the temperature of articles (items) in logistics and events showing the temperatures of the items, pallets, and containers are to be generated.

First, an operation of accumulating the events will be described by showing specific values.

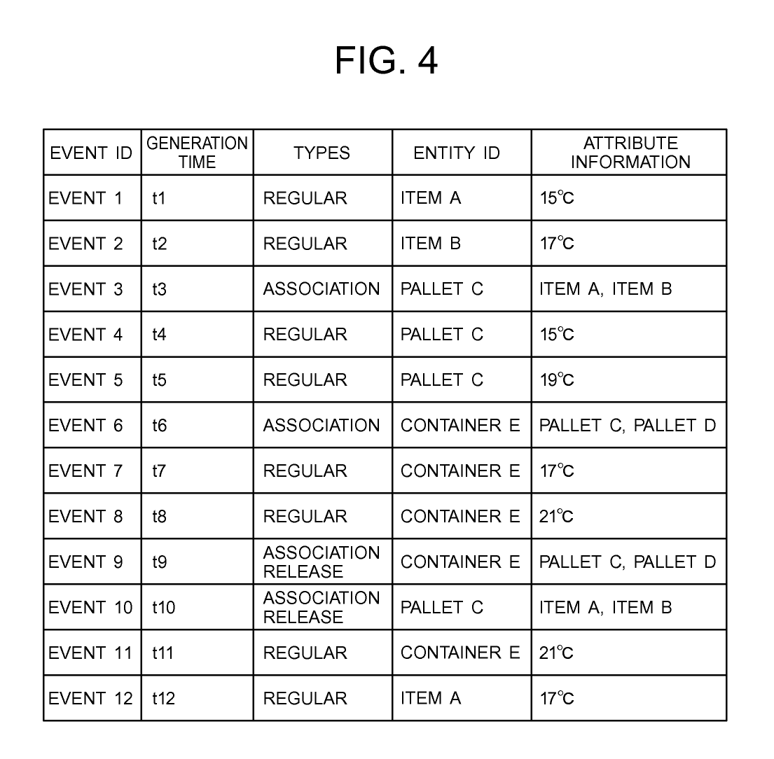

FIG. 4 is a table showing an event history stored in the event storage unit 12 in the specific example. As the initial state, the event storage unit 12, the index storage unit 20, and the association information storage unit 15 are empty.

First, an event whose entity ID is “item A” and whose attribute information is “15° C.” is generated at time “t1” in the host system 1. When it is inputted to the even input module 11, the event recording module 13 registers the event to which “event 1” as the event ID is applied to the event storage unit 12. This event is a regular event. Thus, the index creation module 19 refers to the association information storage unit 15 to check that there is no association information containing “item A”, and registers the index information in which “15° C.”, “event 1”, and the list ID “null” are associated to the index storage unit 20. Subsequently, when an event of generation time “t2” is inputted, the information is updated to information stored in the event storage unit 12 and the index storage unit 20 by applying event ID “event 2” in the same manner.

When an event whose generation time is “t3”, whose entity ID is “pallet C”, and whose attribute information is “item A, item B” is inputted, the event recording module 13 registers the event to which “event 3” as the event ID is applied to the event storage unit 12. This event is an association event. Thus, the association setting module 14 takes the entity ID “pallet C” as the main monitored object ID and the attribute information “item A, item B” as the subordinate monitored object ID, and registers, to the association information storage unit 15, the association information in which a list ID “list a” is applied to the association list in which the subordinate monitored object ID “item A, item B” is associated with the main monitored object ID “pallet C”. In this specific example, a table constituted with the association list containing “pallet C”, “item A, item B”, the list ID “list a”, and the effective time range is registered to the association information storage unit 15 as the association information. The start time of the effective time range of this case is “t3”, and the end time is unsettled.

When an event whose generation time is “t4”, whose entity ID is “pallet C, and whose attribute information is “15° C.” is inputted, the event recording module 13 registers the event to which “event 4” is applied as the event ID to the event storage unit 12. This event is a regular event. Thus, the index creation module 19 refers to the association information storage unit 15 to specify “list a” as the association list (effective at the time t4) which contains “pallet C” as the main monitored object ID, and registers the index information which shows “15° C.”, “event 4”, and “list a” in an associated manner to the index storage unit 20.

Subsequently, when an event whose generation time is “t5”, whose entity ID is “pallet C”, and whose attribute information is “19° C.” is inputted, the information is updated to information stored in the event storage unit 12 and the index storage unit 20 by applying event ID “event 5” as in the case of inputting “event 4”.

When an event whose generation time is “t6”, whose entity ID is “container E”, and whose attribute information is “pallet C, pallet D” is inputted, the event recording module 13 registers the event to which “event 6” as the event ID is applied to the event storage unit 12. This event is an association event. Thus, the association setting module 14 searches the association list containing “pallet C, pallet D” that is the attribute information of “event 6” from the association information storage unit 15, selects the association list of the list ID “list a”, and registers, to the association information storage unit 15, the association information in which a list ID “list b” is applied to a new association list in which “pallet C”, “pallet D”, “item A”, “item B” as the merged result of the association list of “list a” and the attribute information of “event 6” are associated with “container E” that is the entity ID of “event 6”. In this specific example, a table constituted with “pallet E” as the main monitored object, “pallet C”, “pallet D”, “item A”, “item B” as the subordinate monitored object IDs, the list ID “list b”, and the effective time range is registered to the association information storage unit 15 as the association information. The start time of the effective time range of this case is “t6”, and the end time is unsettled.

When an event whose generation time is “t7”, whose entity ID is “container E, and whose attribute information is “17° C.” is inputted, the event recording module 13 registers the event to which “event 7” is applied as the event ID to the event storage unit 12. This event is a regular event. Thus, the index creation module 19 refers to the association information storage unit 15 and acquires “list b” of the association list (effective at time t7) which contains “container E” as the main monitored object. Then, index information taking “17° C.” as the key and having “event 7” and “list b” as the values is recorded in the index storage unit 20.

Subsequently, when an event whose generation time is “t8”, whose entity ID is “container E”, and whose attribute information is “21° C.” is inputted, the information stored in the event storage unit 12 and the index storage unit 20 is updated by applying event ID “event 8” as in the case of inputting “event 7”.

When an event whose generation time is “t9”, whose entity ID is “container E”, and whose attribute information is “pallet C”, “pallet D” is inputted, the event recording module 13 registers the event to which “event 9” as the event ID is applied to the event storage unit 12. This event is an association release event. Thus, the association setting module 14 searches the association list containing “container E” as the main monitored object ID from the association information storage unit 15, specifies the association list of the list ID “list b”, and sets the end time of the effective time range for the association list of “list b” as t9.

When an event whose generation time is “t10”, whose entity ID is “pallet C”, and whose attribute information is “item A”, “item B” is inputted, the information stored in the event storage unit 12 and the association information storage unit 15 is updated by applying event ID “event 10” as in the case of inputting “event 9”.

When an event whose generation time is “t11”, whose entity ID is “container E, and whose attribute information is “21° C.” is inputted, the event recording module 13 registers the event to which “event 11” is applied as the event ID to the event storage unit 12. This event is a regular event. Thus, the index creation module 19 refers to the association information storage unit 15 to check that there is no association list regarding “container E”, and records the index information in which “21° C.”, “event 11”, and the list ID “null” are associated to the index storage unit 20.

When an event whose generation time is “t12”, whose entity ID is “item A”, and whose attribute information is “17° C.” is inputted, the information stored in the event storage unit 12 and the index storage unit 20 is updated by applying event ID “event 12” as in the case of inputting “event 11”.

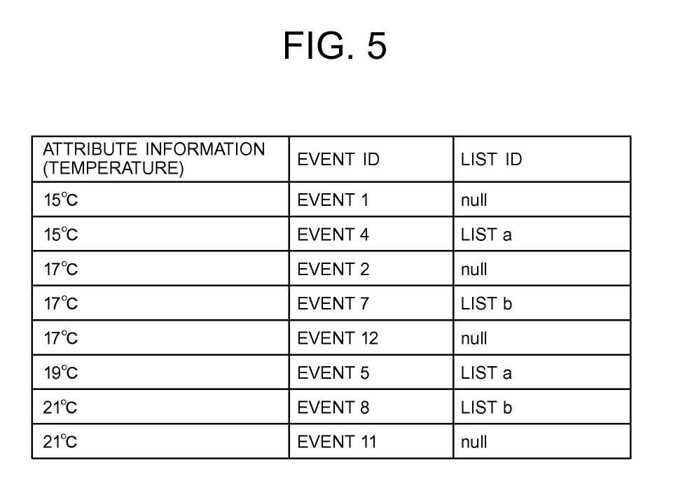

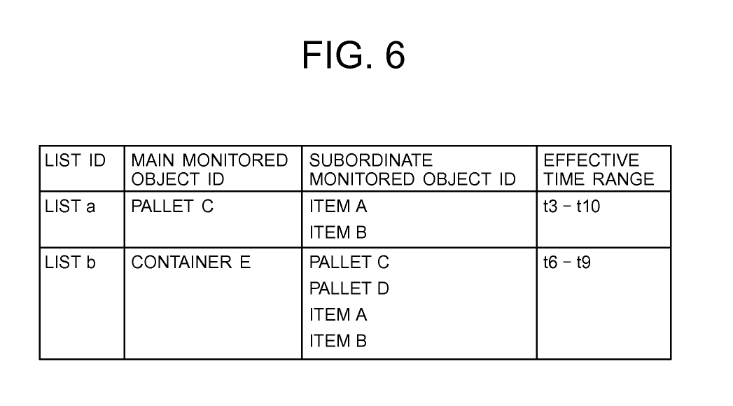

Through the above-described procedure, the event history as shown in FIG. 4 is stored in the event storage unit 12, the association information as shown in FIG. 6 is stored in the association information storage unit 15, and the index information as shown in FIG. 5 is stored in the index storage unit 20.

Next, an event search operation of the specific example will be described.

As the initial state, it is so assumed that the event history as shown in FIG. 4 is stored in the event storage unit 12, the index information as shown in FIG. 5 is stored in the index storage unit 20, and the association information as shown in FIG. 6 is stored in the association information storage unit 15.

First, the search request input module 16 inputs a search request having a search condition of “item whose temperature is measured as 20° C. or higher between time t1 and t12”. Upon this, the search module 17 searches the index information with the temperature of 20° C. or higher from the index storage unit 20. In the information shown in FIG. 5, “event 8” and “event 11” are acquired as the search result.

In the index information of the “event 8”, “list b” is recorded as the list ID. Thus, the association list of “list b” is searched from the association information storage unit 15, and all the monitored object IDs contained in the association list of “list b” are extracted. As the result thereof, “pallet C”, “pallet D”, “item A”, and “item B” are extracted. Among those, “item A” and “item B” that match the entity type of the search condition are considered as the search result. Then, the entity ID regarding “event 8” is acquired from the event storage unit 12. However, that is “container E” which does not match the entity type of the search condition. Thus, it is not included in the search result.

In the meantime, in the index information of “event 11”, “null” is recorded in the list ID. Thus, the entity ID regarding “event 11” is searched from the event storage unit 12. The result is “container E” which does not match the entity type of the search condition, so that it is not included in the search result.

All the index information is processed through the above operation. Thus, “item A” and “item B” as a set of the search result are outputted to the host system 2 from the search result output module 18.

Note here that the functional contents of the event input module 11, the event recording module 13, the association setting module 14, the index creation module 19, the search request input module 16, the search module 17, and the search result output module 18 may be put into a program to be executed by a computer. Further, the program may be recorded in a non-transitory recording medium such as a DVD, a CD, or a flash memory. In that case, the program is read out from the recording medium and executed by the computer.

As described above, the event information management system 1 of the exemplary embodiment registers, at the time of registering an event, the list ID of the association list containing the entity ID of the event as the main monitored object ID along with the attribute information of the event as the index information. At the time of searching, the event information management system 1 specifies the list ID corresponding to the attribute information that matches the search condition by searching the index information, and then reads out the monitored object ID contained in the association list corresponding thereto as the search result. Thus, it is possible to search the state of all the monitored objects without recording the state of all the monitored objects. Further, it is possible to suppress the memory use amount and the search processing time even when the number of the monitored objects is increased.

Next, a second exemplary embodiment according to the present invention will be described.

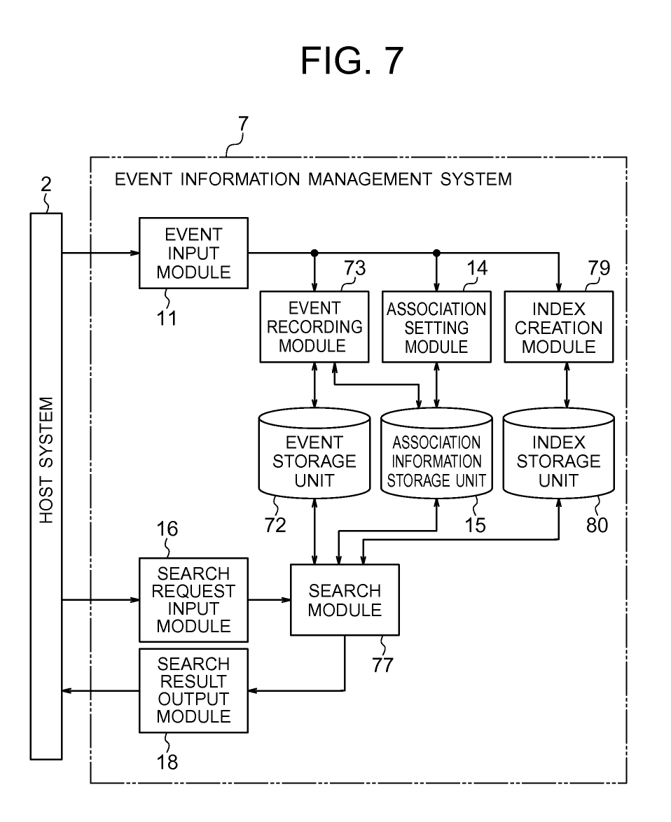

FIG. 7 is a functional block diagram showing the structure of an event information management system 7 according to the second exemplary embodiment. In FIG. 7, same reference numerals as those of FIG. 1 are applied to the structural elements that have the same functions as those of the event information management system 1 of the first exemplary embodiment described above.

The event information management system 7 of the second exemplary embodiment is different from the first exemplary embodiment in respect that: an event recording module 73 includes a function which selects the list ID of the association list containing the entity ID of an inputted event as the main monitored object ID from the association information storage unit 15 and registers the list ID and the event to an event storage unit 72 in a corresponding manner; and a search module 77 includes a function which extracts the event ID of the attribute information that matches the search condition of an inputted search request from an index storage unit 75, reads out the list ID corresponding to the event ID from the event storage unit 72, and reads out the monitored object ID contained in the association list of the list ID from the association information storage unit 15. Thereby, the event storage unit 72 stores the list ID by each event. Thus, the index storage unit 75 may not store the list ID.

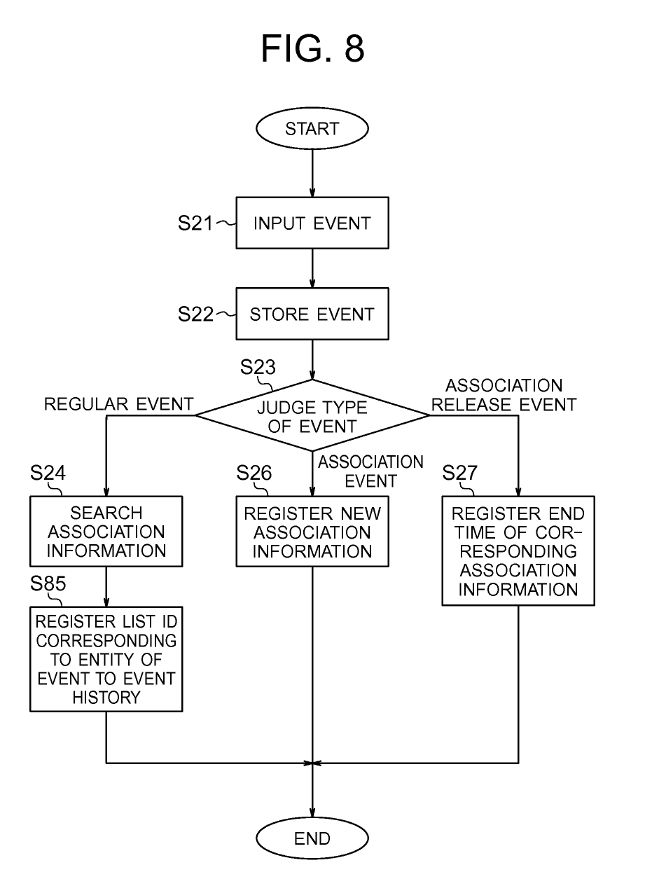

FIG. 8 is a flowchart showing an event recording operation of the event information management system 7 of the second exemplary embodiment. In the second exemplary embodiment, when the inputted event is a regular event, the event recording module 73 refers to the association information storage unit 15, judges whether or not there is an association list that contains the main monitored object ID that matches the entity ID of the event and, when judged that there is, checks whether or not the event generation time is within the effective time range of the association list (step S24 of FIG. 8). When there is the association list and the event generation time is within the effective time range of the association list, the list ID of the association list is extracted and registered to the event storage unit 72 by associating it with the event (step S85 of FIG. 8). The other steps are the same as the operation of the first exemplary embodiment described above.

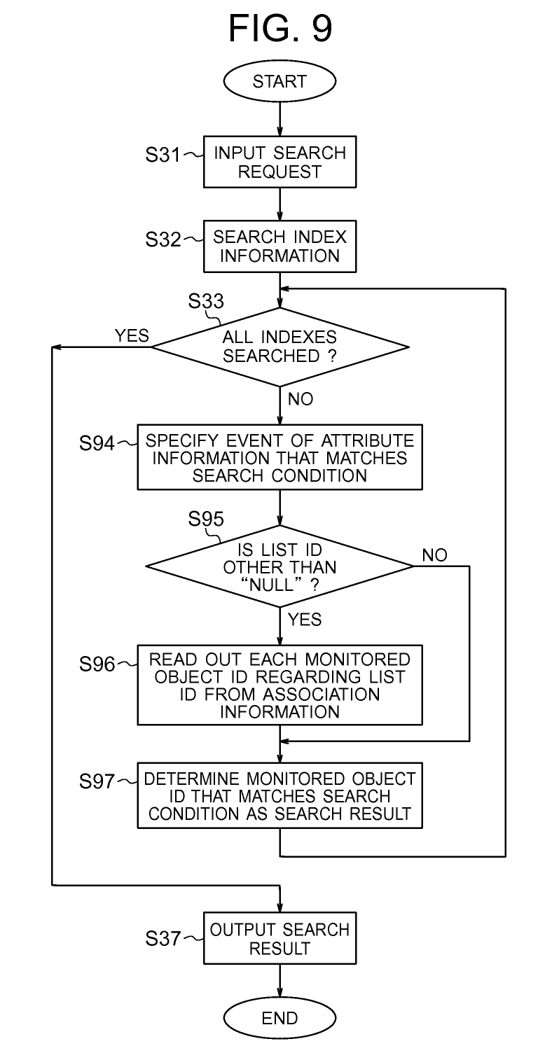

FIG. 9 is a flowchart showing a search operation of the event information management system 7 of the second exemplary embodiment. In the second exemplary embodiment, the search module 77 searches the index storage unit 75 to specify the event ID of the attribute information that matches the search condition, and reads out the event entity ID of the event and the list ID associated with the event from the event storage unit 72 (step S94 of FIG. 9). When the list ID is other than “null” (Yes in step S95 of FIG. 9), a list of monitored object IDs contained in the association list of the list ID is read out from the association information storage unit 15 (step S96 of FIG. 9). The search module 77 sends those that match the entity type of the search condition among the set of all the monitored object IDs read out from the association list and the entity ID read out from the event storage unit 72 to the search result output module 18 as the search result (step S97 of FIG. 9). The other steps are the same as the operation of the first exemplary embodiment described above.

With the second exemplary embodiment, when there are two types of attribute information such as the positional information and the temperature information, for example, both of the attribute information can be shared between the main monitored object and the subordinate monitored objet housed therein. Thus, in a case where there are a plurality of types of event attribute information, it is possible to cut the cost for the memory by setting relation list information in common to each type of attribute information and storing it into the event storage unit 12 by applying the list ID to the event instead of carrying association information for each type of the attribute information.

A part of or a whole part of the above-described embodiments can be written as follows. However, it is to be note that the present invention is not limited only to the followings.

### (Supplementary Note 1)

An event information management system which includes: an event input module which sequentially inputs events containing attribute information that is information showing state of a monitored object and an entity ID as an individual identifier of the monitored object that is a subject of the attribute information; an association setting module which operates when the attribute information of the inputted event shows an individual identifier that is different from the entity ID of the event, sets the entity ID of the event to a main monitored object ID, sets the individual identifier shown by the attribute information of the event to a subordinate monitored object ID, and creates association information by applying a specific list identifier to an association list in which the main monitored object ID is associated with the subordinate monitored object ID; an association information storage unit which stores the created association information; an index information creation module which operates when the attribute information of the inputted event shows a physical quantity value regarding the monitored object, searches whether or not the entity ID of the event is registered as the main monitored object ID in the association information storage unit and, when judged as being registered, creates index information in which the list identifier corresponding to the main monitored object ID is associated with the physical quantity value shown by the attribute information of the event; and an index storage unit which stores the created index information for searching the event.

### (Supplementary Note 2)

The event information management system as depicted in Supplementary Note 1, which includes: a search request input module which inputs a search request containing a physical quantity value designated by an administrator as a search condition; a search module which searches the list identifier that is associated with a value matching the search condition from the index storage unit in response to the search request, and reads out the main and subordinate object IDs of the association list regarding the searched list identifier from the association information storage unit; and a search result output module which outputs the read out main and subordinate monitored object IDs as a search result.

### (Supplementary Note 3)

The event information management system as depicted in Supplementary Note 2, which includes: an event storage unit which accumulates the events inputted by the event input module; and an event recoding module which reads out the list identifier of the association list which takes the entity ID of the inputted event as the main monitored object ID from the association information storage unit, associates it with the event and registers to the event storage unit, wherein the search module searches the event storage unit when searching the list identifier that satisfies the search condition.

### (Supplementary Note 4)

An event management method, wherein: an event input module sequentially inputs events containing attribute information that is information showing state of a monitored object and an entity ID as an individual identifier of the monitored object that is a subject of the attribute information; when the attribute information of the inputted event shows an individual identifier that is different from the entity ID of the event, an association setting module sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to an association information storage unit; and when the attribute information of the inputted event shows a physical quantity value regarding the monitored object, an index information creation module searches the main monitored object ID that matches the entity ID of the event from the association information storage unit, creates index information in which the list identifier corresponding to the main monitored object ID is associated with the physical quantity value shown by the attribute information of the event, and stores it to an index storage unit for searching the event.

### (Supplementary Note 5)

The event information management method as depicted in Supplementary Note 4, wherein: after storing the index information to the storage unit, a search request input module inputs a search request containing a physical quantity value designated by an administrator as a search condition; a search module searches the list identifier that is associated with a value matching the search condition from the index information in response to the inputted search request; the search module reads out the main and subordinate object IDs of the association list regarding the searched list identifier from the association information storage unit; and a search result output module outputs each of the read out main and subordinate monitored object IDs as a search result.

### (Supplementary Note 6)

The event information management method as depicted in Supplementary Note 5, wherein: an event recoding module reads out the list identifier of the association list which takes the entity ID of the event inputted by the event input module as the main monitored object ID from the association information storage unit, associates it with the event and registers to the event storage unit; and the search module searches the event storage unit when searching the list identifier that satisfies the search condition.

### (Supplementary Note 7)

An event information management program for causing a computer to execute: an event input function which sequentially inputs events containing attribute information that is information showing state of a monitored object and an entity ID as an individual identifier of the monitored object that is a subject of the attribute information; an association information creating function which operates when the attribute information of the inputted event shows an individual identifier that is different from the entity ID of the event, sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to a storage unit; and an index information creating function which operates when the attribute information of the inputted event shows a physical quantity value regarding the monitored object, searches whether or not the entity ID of the event is registered as the main monitored object ID in the association information and, when judged as being registered, creates index information in which the list identifier corresponding to the main monitored object ID is associated with the physical quantity value shown by the attribute information of the event, and stores it to the storage unit for searching the event.

### (Supplementary Note 8)

The event information management program as depicted in Supplementary Note 7, which causes the computer to execute: a search request input function which inputs a search request containing a physical quantity value designated by an administrator as a search condition; a search function which searches the list identifier that is associated with a value matching the search condition from the index information in response to the inputted search request; a function which reads out the main and subordinate object IDs of the association list regarding the searched list identifier from the storage unit; and a function which outputs the read out main and subordinate monitored object IDs as a search result.

### (Supplementary Note 9)

The event information management program as depicted in Supplementary Note 8, which causes the computer to execute: an event recoding function which reads out the list identifier of the association list which takes the entity ID of the inputted event as the main monitored object ID from the association information storage unit, associates it with the event and registers to the event storage unit as an event history, wherein the search function is a function which searches the event history when searching the list identifier that satisfies the search condition.

While the present invention has been described heretofore by referring to the embodiments (and EXAMPLES), the present invention is not limited only to the embodiments (and EXAMPLES). Various changes and modifications occurred to those skilled in the art can be applied to the structures and details of the present invention without departing from the scope of the present invention.

This Application claims the Priority right based on Japanese Patent Application No. 2010-035314 filed on Feb. 19, 2010 and the disclosure thereof is hereby incorporated by reference in its entirety.

### INDUSTRIAL APPLICABILITY

The present invention can be applied to a technique for saving and managing events generated in a business work system.

### REFERENCE NUMERALS

1 Event information management system
2 Host system
11 Event input module
12, 72 Event storage unit
13, 73 Event recording module
14 Association setting module
15 Association information storage unit
16 Search request input module
17, 77 Search module
18 Search result output module
19, 79 Index creation module
20, 80 Index information storage unit

1. An event information management system, comprising:
an event input module which sequentially inputs events containing attribute information that is information showing state of a monitored object and an entity ID as an individual identifier of the monitored object that is a subject of the attribute information;
an association setting module which operates when the attribute information of the inputted event shows an individual identifier that is different from the entity ID of the event, sets the entity ID of the event to a main monitored object ID, sets the individual identifier shown by the attribute information of the event to a subordinate monitored object ID, and creates association information by applying a specific list identifier to an association list in which the main monitored object ID is associated with the subordinate monitored object ID;
an association information storage unit which stores the created association information;
an index information creation module which operates when the attribute information of the inputted event shows a physical quantity value regarding the monitored object, searches whether or not the entity ID of the event is registered as the main monitored object ID in the association information storage unit and, when judged as being registered, creates index information in which the list identifier corresponding to the main monitored object ID is associated with the physical quantity value shown by the attribute information of the event; and
an index storage unit which stores the created index information for searching the event.

2. The event information management system as claimed in claim 1, comprising:
a search request input module which inputs a search request containing a physical quantity value designated by an administrator as a search condition; a search module which searches the list identifier that is associated with a value matching the search condition from the index storage unit in response to the search request, and reads out the main and subordinate object IDs of the association list regarding the searched list identifier from the association information storage unit; and
a search result output module which outputs the read out main and subordinate monitored object IDs as a search result.

3. The event information management system as claimed in claim 2, comprising:
an event storage unit which accumulates the events inputted by the event input module; and
an event recoding module which reads out the list identifier of the association list which takes the entity ID of the inputted event as the main monitored object ID from the association information storage unit, associates it with the event and registers to the event storage unit, wherein
the search module searches the event storage unit when searching the list identifier that satisfies the search condition.

4. An event management method, wherein:
an event input module sequentially inputs events containing attribute information that is information showing state of a monitored object and an entity ID as an individual identifier of the monitored object that is a subject of the attribute information;
when the attribute information of the inputted event shows an individual identifier that is different from the entity ID of the event, an association setting module sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to an association information storage unit; and
when the attribute information of the inputted event shows a physical quantity value regarding the monitored object, an index information creation module searches the main monitored object ID that matches the entity ID of the event from the association information storage unit, creates index information in which the list identifier corresponding to the main monitored object ID is associated with the physical quantity value shown by the attribute information of the event, and stores it to an index storage unit for searching the event.

5. The event information management method as claimed in claim 4, wherein:
after storing the index information to the storage unit, a search request input module inputs a search request containing a physical quantity value designated by an administrator as a search condition;
a search module searches the list identifier that is associated with a value matching the search condition from the index information in response to the inputted search request;
the search module reads out the main and subordinate object IDs of the association list regarding the searched list identifier from the association information storage unit; and
a search result output module outputs each of the read out main and subordinate monitored object IDs as a search result.

6. A non-transitory computer readable recording medium storing an event information management program for causing a computer to execute:
an event input function which sequentially inputs events containing attribute information that is information showing state of a monitored object and an entity ID as an individual identifier of the monitored object that is a subject of the attribute information;
an association information creating function which operates when the attribute information of the inputted event shows an individual identifier that is different from the entity ID of the event, sets the entity ID of the event to a main monitored object ID, sets the individual identifier shown by the attribute information of the event to a subordinate monitored object ID, creates association information by applying a specific list identifier to an association list in which the main monitored object ID is associated with the subordinate monitored object ID, and stores it to a storage unit; and
an index information creating function which operates when the attribute information of the inputted event shows a physical quantity value regarding the monitored object, searches whether or not the entity ID of the event is registered as the main monitored object ID in the association information and, when judged as being registered, creates index information in which the list identifier corresponding to the main monitored object ID is associated with the physical quantity value shown by the attribute information of the event, and stores it to the storage unit for searching the event.

7. The non-transitory computer readable recording medium storing the event information management program as claimed in claim 6, which causes the computer to execute:
a search request input function which inputs a search request containing a physical quantity value designated by an administrator as a search condition; a search function which searches the list identifier that is associated with a value matching the search condition from the index information in response to the inputted search request; a function which reads out the main and subordinate object IDs of the association list regarding the searched list identifier from the storage unit; and a function which outputs the read out main and subordinate monitored object IDs as a search result.

8. An event information management system, comprising:
event input means for sequentially inputting events containing attribute information that is information showing state of a monitored object and an entity ID as an individual identifier of the monitored object that is a subject of the attribute information;
association setting means for operating when the attribute information of the inputted event shows an individual identifier that is different from the entity ID of the event, setting the entity ID of the event to a main monitored object ID, setting the individual identifier shown by the attribute information of the event to a subordinate monitored object ID, and creating association information by applying a specific list identifier to an association list in which the main monitored object ID is associated with the subordinate monitored object ID;
association information storage means for storing the created association information;
index information creation means for operating when the attribute information of the inputted event shows a physical quantity value regarding the monitored object, searching whether or not the entity ID of the event is registered as the main monitored object ID in the association information storage means and, when judged as being registered, creating index information in which the list identifier corresponding to the main monitored object ID is associated with the physical quantity value shown by the attribute information of the event; and
index storage means for storing the created index information for searching the event.
